(19) United States
(12) Patent Application Publication
(10) Pub. No.: US 2001/0023187 A1
(43) Pub. Date: Sep. 20, 2001

(54) Process, terminal and infrastructure devices for forming terminal groups in a mobile-radio telecommunications network

(76) Inventor: Michael Wilhelm, Vaihingen/Enz-3 (DE)

Correspondence Address: SUGHRUE, MION, ZINN, MACPEAK & SEAS, PLLC, 2100 Pennsylvania Avenue, N. W., Washington, DC, 20037-3213, US

(21) Appl. No.: 09/796,652

(22) Filed: Mar. 2, 2001

(30) Foreign Application Priority Data
Mar. 16, 2000 (DE) 100 12 945.5

(51) Int. Cl. H04Q 7/20; H04B 7/00

(52) U.S. Cl. 455/518; 455/509; 455/519

(57) ABSTRACT

The present invention relates to a process for managing a first and at least one second mobile-radio terminal (M1, M2) which are each able to set up connections over a mobile-radio telecommunications network (NET) to communication-partner terminals (KPM1, KPM2, KPM3), and also to a device for said process, a program module for a device for said process, a mobile-radio terminal for said process, a program module for a mobile-radio terminal for said process and an identification module for a mobile-radio terminal for said process.

The first and the at least one second terminal (M1, M2) are assigned to a common mobile-radio terminal group (GRP) to which a common subscriber number (GRPNR) is assigned. Furthermore, a first identifier (ID1) is assigned to the first terminal (M1), and a second identifier (ID2) is assigned to the at least one second terminal (M2). The first and the at least one second identifier (ID1, ID2) are evaluated when call connections (C11, C12, C13) are set up over the telecommunications network (NET) between the first terminal (M1) or the at least one second terminal (M2) and the communication-partner terminals (KPM1, KPM2, KPM3).

The present invention relates to a process for managing a first and at least one second mobile-radio terminal which are each able to set up connections over a mobile-radio telecommunications network to communication-partner terminals, as set forth in the preamble to claim 1, and also to a device as set forth in the preamble to claim 12, a program module as set forth in the preamble to claim 13, a mobile-radio terminal as set forth in the preamble to claim 14, a program module for a mobile-radio terminal as set forth in the preamble to claim 15 and an identification module for a mobile-radio terminal as set forth in the preamble to claim 16.

Ordinarily, an individual, subscriber-specific licence as well as an individual subscriber number are allocated to a subscriber who would like to avail himself of the telecommunications services of a mobile-radio telecommunications network. These subscriber-specific data are stored on a so-called SIM module (SIM=Subscriber Identity Module) which is inserted into a mobile-radio terminal belonging to the subscriber. Further subscriber-specific data are saved in one or more databases pertaining to the mobile-radio telecommunications network. If the subscriber then logs on to the mobile-radio telecommunications network with his mobile-radio terminal, the terminal and the telecommunications network exchange a portion of their respective subscriber-specific data. In this way it is ensured that, in each instance, only one subscriber is able to log on to the telecommunications network by utilising his respective subscriber-specific data relating to his respective subscriber licence.

With the known process each subscriber must accordingly acquire a personal licence with a view to utilising the telecommunications services of the telecommunications network. Given the customary monthly standing charges, however, such a licence can be very expensive under certain circumstances.

If a subscriber possesses not just one mobile-radio terminal but several terminals but possesses only one mobile-radio licence, the subscriber has to insert his SIM card into the terminal that he would like to use on each occasion. This is the case, for example, if the subscriber would like to use, on the one hand, a mobile-radio terminal that is installed in his motor vehicle and, on the other hand, a terminal that he also carries with him outside the motor vehicle. The respective interchanging of the SIM card is inconvenient and laborious for the subscriber.

The object of the invention is therefore to make a plurality of mobile-radio terminals that belong to a subscriber or to a group of subscribers capable of being used comfortably and conveniently.

This object is achieved by virtue of a process according to the technical teaching of claim 1 and also a device according to the technical teaching of claim 12, a program module according to the technical teaching of claim 13, a mobile-radio terminal according to the technical teaching of claim 14, a program module for a mobile-radio terminal according to the technical teaching of claim 15 and an identification module for a mobile-radio terminal according to the technical teaching of claim 16.

In this regard, the idea underlying the invention is to combine several mobile-radio terminals into a common mobile-radio terminal group. To this terminal group a common subscriber number is assigned, under which the respective terminals of the terminal group are accessible to communication partners. The terminals of the terminal group are furthermore each given an individual identifier with which the terminals are capable of being distinguished. With the aid of this identifier the telecommunications network can assign incoming call connections for the terminal group individually in each instance to a terminal of the terminal group. Consequently it is possible in the case of the example stated in the introduction, for example, to assign both the terminal that is installed in the motor vehicle and the terminal that is capable of being used outside the motor vehicle to a common mobile-radio terminal group, in respect of which only one mobile-radio licence is then required. Also for members of a group of persons, for example for members of a family or a working group, it is advantageous if they use terminals that have been combined into a terminal group in such a way. This is because the members of the group can be reached via a common subscriber number, so that an external communication partner does not have to remember individual subscriber numbers on each occasion but only the common subscriber number.

Further advantageous configurations of the invention result from the dependent claims.

For the terminal group a maximum number of simultaneous call connections, e.g. one or two call connections, may be permitted to communication-partner terminals outside the terminal group or between the terminals of the terminal group. In this way it is possible, by virtue of a group licence assigned to a family for example, on the one hand for the respective communications network to be used optimally in terms of capacity and on the other hand for an excessive and therefore cost-intensive utilisation of the group licence to be avoided.

In an advantageous variant the respective terminal-specific identifier which is assigned to a terminal of a terminal group is transmitted in each instance from the terminal to the telecommunications network. The latter is consequently able to recognise whether the terminal is ready for communication. Furthermore, it is possible for the identifier to take the form of a final digit which can be dialled by a communication partner in addition to the subscriber number assigned to the terminal group. The terminals are then treated by the telecommunications network like a private branch exchange with subscriber-specific direct dialling, in which each of the terminals of the terminal group is addressable individually over the telecommunications network. Furthermore, it is possible for the telecommunications network to allocate such an identifier individually to the respective terminals of a terminal group when the terminals log on to the telecommunications network.

Within the terminal group one of the terminals can be designated as a preferred destination for incoming call connections from the telecommunications network that are directed to the subscriber number of the terminal group. Thus, for instance, the subscriber who was mentioned in the introduction, who operates both a terminal that is installed in his motor vehicle and a terminal that is capable of being used outside the motor vehicle, can define the terminal installed in the motor vehicle as a temporary preferred destination for incoming call connections as long as the subscriber is located in the motor vehicle.

In a further variant of the invention, one of the terminals of a terminal group is given a so-called master authorization. Only with this master authorization is it then possible to modify parameters of the terminal group as a whole or of individual terminals of the terminal group. Such a parameter is, for example, whether a terminal is to be treated as preferred destination for incoming calls. With the aid of the master authorization, individual terminals of the group can also be disabled or enabled for call connections. The functions that are assigned to the master authorization are preferably protected by one or more passwords.

If the maximum number of call connections allowed simultaneously for a terminal group is less than the number of terminals, a connection request that has been sent from a terminal of the terminal group to the telecommunications network may possibly not be fulfilled. The telecommunications network then enters the connection request into a queue and establishes the desired connection as soon as the aforementioned maximum number of call connections has been fallen short of again. The order of the processing of connection requests that have been entered into such a queue may be dependent on destination call numbers specified in the respective connection requests and/or on the order of their entry into the queue.

In a further variant of the invention, a call connection that leads to a terminal of a terminal group can be switched onward over the telecommunications network from said terminal to another terminal of the terminal group. For this purpose the former terminal sends an instruction to the telecommunications network to switch the respective call connection over to the latter terminal.

Combinations of the variants described above and also of the solutions specified in the dependent claims are readily possible.

The invention as well as further advantageous configurations will be represented in the following on the basis of an embodiment example with the assistance of the Figures. Illustrated are:

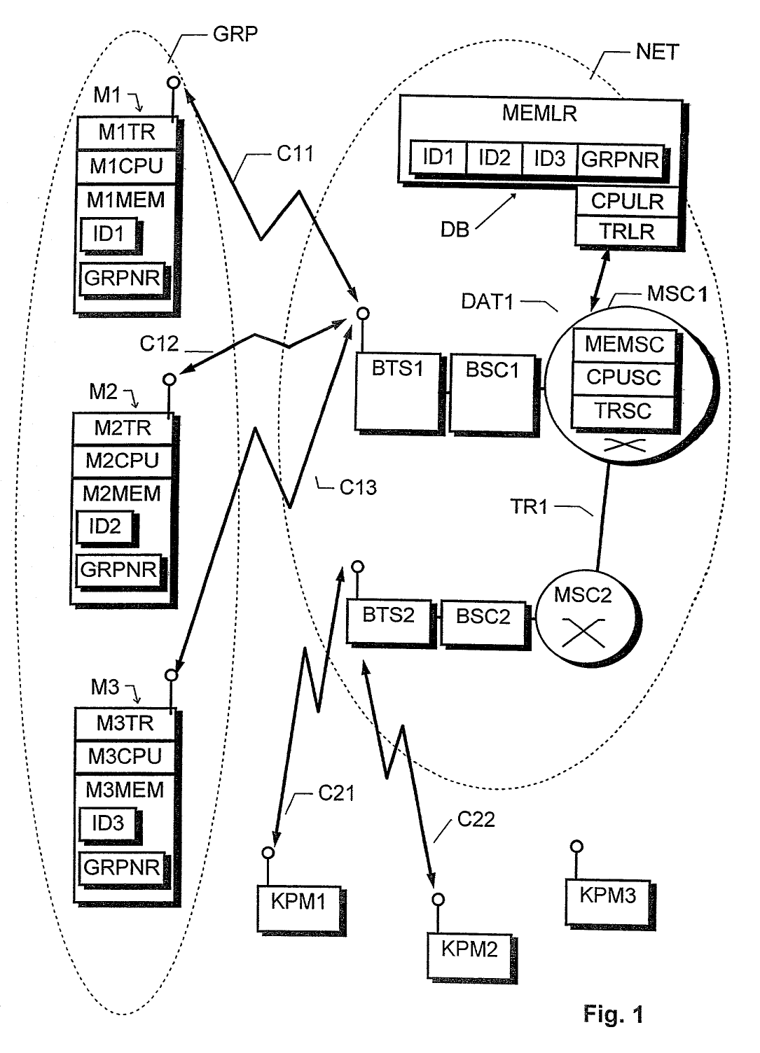

FIG. 1 a schematically represented arrangement for implementing the invention with terminals M1 to M3 according to the invention pertaining to a terminal group GRP, which are operated by a mobile-radio telecommunications network NET,

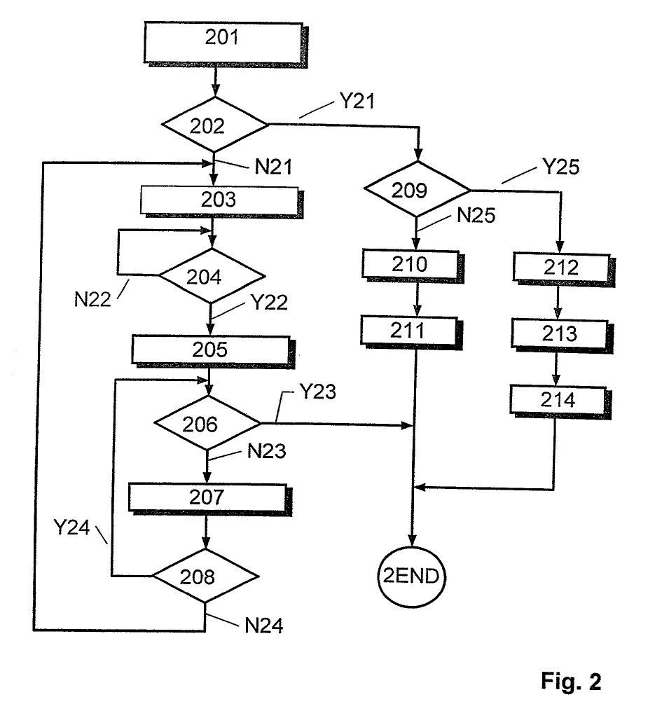

FIG. 2 a handling procedure according to the invention in respect of connection requests which are sent from the terminals M1 to M3 to the telecommunications network NET and

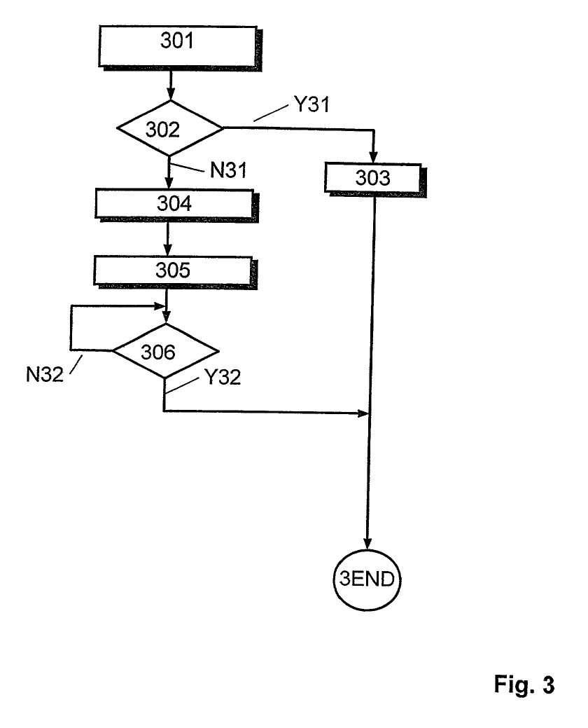

FIG. 3 a handling procedure in respect of incoming calls for the terminal group GRP.

FIG. 1 shows a very schematic arrangement in which a group of mobile-radio terminals M1, M2 and M3 is operated as a terminal group by a telecommunications network NET. The telecommunications network NET is a mobile-radio telecommunications network or a network that permits both mobile-radio communication and line-conducted communication. Of the telecommunications network NET there are shown, in a manner exemplary of other devices which are not represented in FIG. 1, mobile-radio switching centres MSC1 and MSC2 which are connected to one another via a trunk group TR1.

In addition to functions according to the invention, the switching centres MSC1 and MSC2 also perform basic functions that are known from so-called mobile switching centres. An access device BTS1 and also a control device BSC1 for controlling access device BTS1 are assigned to switching centre MSC1. For reason of clarity, further access devices which are assigned to switching centre MSC1 are not represented. Access device BTS1 can, for example, perform functions of a so-called base transceiver station of a mobile-radio network. Access device BTS1 makes a radio interface available for the terminals M1 to M3, this being expressed in FIG. 1 by means of an indicated antenna. Access device BTS1 and control device BSC1 may also be integrated within switching centre MSC1.

Of the switching centre MSC1 there are shown in exemplary manner a number of important components, namely a connection means TRSC and also a control means CPUSC and a memory means MEMSC. With the connection means TRSC switching centre MSC1 is able to set up data links and voice links as well as signalling links to subscribers or to other switching centres. The control means CPUSC is a processor or a group of processors that is/are able to execute program code pertaining to program modules that are stored in the memory means MEMSC. The control means CPUSC controls the functions of switching centre MSC1 and thereby influences, for example, the functions of the connection means TRSC. The connection means TRSC, the control means CPUSC and the memory means MEMSC are interconnected by connections which are not represented in FIG. 1. Moreover, switching centre MSC1 may comprise further units, e.g. a coupling network or an interface to a Network Management System. Switching centre MSC2 may be configured internally just like switching centre MSC1. Switching centre MSC2 may, however, also be a conventional, known switching centre.

Access device BTS1 and control device BSC1 also each comprise memory means and control means, not represented, with which program code pertaining to program modules can be stored or executed. Access device BTS1 may also be integrated within control device BSC1.

An access device BTS2 and also a control device BSC2 are assigned to switching centre MSC2. Access device BTS2 performs functions similar to those performed by access device BTS1, control device BSC2 performs functions similar to those performed by control device BSC1. Access device BTS1, control device BSC1 and switching centre MSC1, as well as access device BTS2, control device BSC2 and switching centre MSC2, are in each instance interconnected.

The mobile-radio terminals M1, M2 and M3 are basically of like structure. Therefore only terminal M1 will be elucidated in more detail in the following. Of terminal M1 there are shown schematically an interface module M1TR, a control means M1CPU and also memory means M1MEM. Further components, such as, for example, a keyboard for the input of commands, a microphone for the input of speech, a loudspeaker for the output of speech, as well as a display for the display of information, are not represented in FIG. 1, for reasons of simplification. Via interface module M1TR, terminal M1 is able to exchange data with the telecommunications network NET by radio. A radio link C11 between terminal M1 and access device BTS1 is drawn in for this purpose in exemplary manner. Control means M1CPU is a processor or an arrangement of processors and it controls the functions of terminal M1. In this regard, control means M1CPU executes program code pertaining to program modules that are saved in memory means M1MEM. Memory means M1MEM contain, for example, so-called RAM modules or flash-ROM chips (RAM=Random Access Memory, ROM Read-Only Memory).

Terminal M2 comprises an interface module M2TR, terminal M3 comprises an interface module M3TR, which each correspond in their function to interface module M1TR. Furthermore, terminals M2 and M3 comprise control means M2CPU and M3CPU, respectively, which basically perform the same functions as control means M1CPU. Furthermore, memory means M2MEM and M3MEM are contained in terminals M2 and M3, respectively, the functions of which correspond to those of memory means M1MEM.

The terminals M1 to M3 form a terminal group GRP to which a common subscriber number GRPNR is assigned. Furthermore, an identifier ID1 is assigned to terminal M1, an identifier ID2 is assigned to terminal M2, and an identifier ID3 is assigned to terminal M3. The subscriber number GRPNR is saved in the respective memory means pertaining to the terminals M1 to M3 and also in a database device DB of the mobile-radio telecommunications network NET. The identifiers ID1 to ID3 are stored in the respectively assigned terminals M1 to M3 and also in the database device DB. With the aid of the identifiers ID1 to ID3 the terminals M1 to M3 can be individually addressed by the telecommunications network NET.

The database device DB is configured in FIG. 1 as a separate device, of which a number of essential components are shown in exemplary manner, namely a connection means TRLR as well as a control means CPULR and a memory means MEMLR. With the connection means TRLR the database device DB can set up a data link DAT1 to switching centre MSC1 and also to other switching centres which are not represented. Via the data link DAT1, switching centre MSC1 has access to the data that are saved in the database device DB. The control means CPULR is a processor or a group of processors that is/are able to execute program code pertaining to program modules that are stored in the memory means MEMLR. The identifiers ID1 to ID3 as well as the subscriber number GRPNR are also stored therein. The control means CPULR controls the functions of the database device DB and thereby influences, for example, the functions of the connection means TRLR. Furthermore, the control means CPULR manages the data that are saved in the memory means MEMLR. The connection means TRLR, the control means CPULR and the memory means MEMLR are interconnected by connections which are not represented in FIG. 1.

The database device DB may also be integrated within switching centre MSC1 or within the access device BTS1 or within control device BSC1. The control means CPUSC then performs the functions of the control means CPULR, and the memory means MEMSC performs the functions of the memory means MEMLR. In such a scenario a so-called Home Location Register, for example, which is managed by switching centre MSC1 and which has been appropriately modified may contain data pertaining to the terminal group GRP. Further data, which are not represented in FIG. 1 for reasons of simplification, may also be saved in the database device DB.

Furthermore, switching centre MSC2 can also access the database device DB and, for example, create a mirror database if a terminal of the terminal group GRP, for example terminal M3, stays for some time in the radio area of access device BTS2 within the context of so-called roaming.

If terminal M1 logs on to the telecommunications network NET, that is to say establishes contact for the first time, terminal M1 sends its identifier ID1 as well as further identification codes to access device BTS1. Further procedures within the context of the logging-on of a terminal to a mobile-radio telecommunications network, for example the exchanging of passwords and the encryption of information, are known as such and will therefore not be elucidated further at this point. Access device BTS1 relays identifier ID1 to control device BSC1, from where the identifier ID1 reaches the database device DB via switching centre MSC1 and is compared by said database device with the identifier ID1 that is already saved. However, it is also possible for only one memory location to be reserved for identifier ID1, which has identifier ID1 assigned to it by the database device DB when terminal M1 logs on to the telecommunications network NET for the first time. Within the context of the entering of identifier ID1 a flag is set at the same time to the effect that terminal M1 is now ready to receive. On the basis of identifier ID1, switching centre MSC1 is able to recognise that terminal M1 is assigned to the terminal group GRP.

However, it is also possible for terminal M1 to send a terminal-group identifier assigned to the terminal group GRP as a whole to access device BTS1 and hence to switching centre MSC1, by which the switching centre MSC1 is able to recognise that terminal M1 belongs to the terminal group GRP. In such a scenario the telecommunications network NET can assign identifier ID1 to terminal M1 anew each time the latter logs on. Identifier ID1 can then, for example, be generated by random number generator or can be allocated as a consecutive number to the respective terminal, depending on the order of logging-on of said terminal. Furthermore, identifier ID1 may also be a final digit pertaining to the subscriber number GRPNR.

In advantageous manner, identifier ID1 and the subscriber number GRPNR are not directly contained in memory means that are permanently installed in terminal M1 but are contained on a so-called SIM module (SIM=Subscriber Identity Module). Such a SIM module is an identification module which is ordinarily arranged on a card. The SIM module may optionally be inserted into terminal M1 or alternatively into another terminal. The respective terminal then reads out the subscriber-specific data that are saved on the identification module and works with the data that have been read out.

With the aid of a program module that is saved in memory means M1MEM and executed by control means M1CPU, terminal M1 can evaluate both identifier ID1 and the subscriber number GRPNR. Furthermore, interface module M1TR is also configured for the purpose of sending and receiving signalling telegrams in which identifier ID1 is included. On the basis of identifier ID1 or on the basis of a further terminal-group identifier which is not represented and which is assigned to the terminal group GRP, terminal M1 is able to recognise that it is assigned to the terminal group GRP.

With a view to setting up a call connection, terminal M1 sends a connection request to access device BTS1 on connection C11. In the connection request, terminal M1 specifies a subscriber number that is assigned to a communication-partner terminal KPM1. Terminal KPM1 is likewise a mobile-radio terminal, but it could also be a fixed-network telephone. Terminal KPM1, just like further terminals KPM2 and KPM3, is operated by switching centre MSC2. According to the connection request, switching centre MSC1 sets up a connection on the trunk group TR1 to switching centre MSC2, from where the connection is then completed via a radio link C21 to terminal KPM1.

Subsequently the mobile-radio terminal KPM2 sends to access device BTS2 on a connection C22 a request for a connection to the terminal group GRP. The subscriber number GRPNR of the terminal group GRP is included in this connection request. Switching centre MSC2 therefore sets up a connection to switching centre MSC1 on the trunk group TR1. Said switching centre MSC1 ascertains, on the basis of a table that is saved in the database device DB, that, although terminal M1 is the preferred call destination within the terminal group GRP, a connection already leads to terminal M1. Therefore switching centre MSC1 sets up, via access device BTS1, a connection C12 to terminal M2 as an alternative call destination. However, it is also possible for only one call connection to be permissible in each instance for the terminal group GRP. In this case, switching centre MSC1 signals to switching centre MSC2 that no connection to the terminal group GRP is possible at the moment, and terminal KPM2 obtains a “busy” tone. Furthermore, it is possible for identifier ID3 to be included in the connection request sent by terminal KPM2, for example in the form of a final digit which is dialled in addition to the subscriber number GRPNR, so that switching centre MSC1 sets up a connection C13 to terminal M3 directly and without regard for preferred destinations. Furthermore, it may also be established that connection requests directed to the terminal group GRP are always to be put through firstly to terminal M3 and are redirected to terminal M1 or M2 only when said terminal M3 cannot be accessed. The data with regard to the preferred destinations in the terminal group GRP are entered in the database device DB.

In the following it is assumed that terminal M1 is maintaining connection C11 and terminal M2 is maintaining connection C12 to access device BTS1. Furthermore, let it be defined that only two simultaneous connections are allowed for the terminal group GRP. If terminal M3 now sends, on a connection C13, a connection request for a connection to terminal KPM3, then switching centre MSC1 determines that the permissible number of connections for the terminal group GRP has already been reached. Switching centre MSC1 therefore sends to terminal M3, for example, an “engaged” signal or a message with an item of information to the effect that the connection request cannot be fulfilled at the moment.

Furthermore, switching centre MSC1 enters the connection request of terminal MR3 into a queue. If now, for example, terminal M2 terminates its connection C12, switching centre MSC1 reads out the connection request of terminal M3 which has been entered in the queue and establishes the desired call connection. If several call-connection requests have been entered in the queue, switching centre MSC1 can ascertain which of these connection requests is to be processed preferentially. In this regard, it is possible, for example, that the connection requests are again processed in the order in which they were entered or that, for example, the connection request entered last is processed first. Furthermore, switching centre MSC1 can also evaluate the destination call numbers entered in the respective connection requests that have been entered in the queue and can handle connection requests to preferred destinations preferentially.

If the connection request sent by terminal M3 is directed to a preferred destination, for example to an emergency call device, then it is also possible for switching centre MSC1 to terminate or interrupt connection C12 or connection C11 in order to establish the connection desired by terminal M3 directly. In this regard, switching centre MSC1 may, for example, send to the respective terminal M1 or M2 an announcement message to the effect that the respective connection C11 or C12 is being interrupted. After terminal M3 has terminated the call connection that has consequently been established, switching centre MSC1 can also re-establish the original connection C12 or C11.

In a further variant, terminal M2, for example, sends to switching centre MSC1 an instruction to the effect that terminal M3, instead of terminal M2, is to take over a connection C12-TR1-C22 existing between terminal M2 and terminal KPM2. Thereupon switching centre MSC1 establishes connection C13 and switches connection C12-TR1-C22 over to the desired connection C13-TR1-C22.

In the example from FIG. 1 a so-called master function is assigned to terminal M1. Terminal M1 is therefore authorized to modify parameters assigned to the terminal group GRP as well as parameters assigned individually to the respective terminals M2 and M3. Such parameters are, for example, the order in which incoming connection requests for the terminal group GRP are to be processed by switching centre MSC1. With a view to modifying such data, firstly a connection is set up between terminal M1 and switching centre MSC1. Then an identification code and also a password are specified at terminal M1, on the basis of which the switching centre MSC1 is able to recognise that terminal M1 is authorized for modification of the data. In this regard, terminal M1 may, for example, execute a so-called WAP browser (WAP=Wireless Application Protocol) via which the terminal M1 can indicate configuration data to its respective operator that have been sent from switching centre MSC1. Via the WAP browser it can be specified at terminal M1, for example, that the maximum number of simultaneous call connections for the terminal group GRP is limited to two call connections or that incoming connection requests are firstly to be put through to terminal M1 and, when the latter is not ready to receive, are to be signalled to terminal M2 and, where appropriate, to terminal M3. Furthermore, via terminal M1, terminal M2 can, for example, also be disabled or enabled for call connections over the telecommunications network NET. Within the scope of the master function particular call destinations, for example especially charge-intensive service call numbers, can also be disabled for all the terminals M1 to M3 of the terminal group GRP. Furthermore, terminal M1 can delegate the master function permanently or temporarily to terminal M2 or to terminal M3. The respective data that have been sent by terminal M1 within the scope of the master function are entered into the database device DB by switching centre MSC1.

FIG. 2 shows a flow chart for a connection request that is sent by terminal M1 to switching centre MSC1 in a step 201. In a checking step 202 switching centre MSC1 checks whether the maximum number of call connections of the terminal group GRP over telecommunications network NET is already being maintained. If this is not the case, switching centre MSC1 comes to a negative result N21 and therefore proceeds to a step 203 in which the switching centre MSC1 sets up the desired call connection and also enters the existence of the call connection into the database device DB. In a checking step 204 switching centre MSC1 checks whether the call connection has been terminated by terminal M1 or by the communication partner thereof. Step 204 is represented in the diagram in FIG. 2 as an endless loop in which step 204 is repeated in each instance in the case of a negative result N22, that is to say in the case of a connection that is still being held by terminal M1. In fact, however, switching centre MSC1 is event-driven, so that the process represented in FIG. 2 “sleeps” until a further process, which is not represented, signals the termination of the call connection being held by terminal M1 to the process represented in FIG. 2 as event Y22, so that said process is “woken up”, that is to say continued.

If the call connection of terminal M1 has been terminated, switching centre MSC1 enters the associated status information with respect to terminal M1 into the database device DB and checks in a subsequent step 206 whether there are any connection requests in the queue for connection requests that was already mentioned in connection with FIG. 1.

If the queue is empty, in a transition Y23 the program moves on to an end step 2END. However, if in step 206 switching centre MSC1 comes to the result N23 that a connection request is still stored in the queue, then in a step 207 switching centre MSC1 signals to the terminal concerned that the respective terminal is now able to set up a connection. The stated signalling may, for example, be effected in the form of a so-called SMS message (SMS=Short Message Service) or as some other signalling message to the respective terminal on a signalling channel. Furthermore, it is possible in step 207 for switching centre MSC1 to set up the connection directly that has been registered and that is stored in the queue. Simultaneously with the stated signalling, switching centre MSC1 starts a timer with a predetermined running-time, within which the respective terminal has to set up the connection that is now possible.

In a step 208 switching centre MSC1 checks whether the timer has expired. If this is the case, switching centre MSC1 goes back again in a transition Y24 to step 206 and checks whether there are further connection requests in the queue.

However, if switching centre MSC1 receives during the running-time of the timer in step 208 a connection request from the terminal to which the possibility of a connection has been signalled, then the switching centre goes back again in a transition N24 to step 203 and sets up the desired call connection and removes the connection request from the queue.

If switching centre MSC1 has come to the result in step 202 that all the connections available to the terminal group GRP are already occupied, switching centre MSC1 moves on, in a transition designated by Y21, to a step 209 in which a check is carried out as to whether the connection request relates to an emergency call or to a call to a preferred destination. If this is not the case, then in a transition N25 the program proceeds to a step 210 in which the terminal M1 receives a signal to the effect that no call is possible at the moment. In a step 211 the connection request is then entered into the queue and the program proceeds to the end step 2END.

If switching centre MSC1 arrives in step 209 at the result that the connection request that was received in step 201 relates to an emergency call or to a call to a preferred destination, in a transition Y25 it passes to a step 212 in which a terminal is selected, the call connection of which is now to be interrupted. In a step 213 switching centre MSC1 signals to this terminal that the call connection thereof is being terminated and it terminates or interrupts the call connection thereof. Furthermore, in step 213 it may also be recorded that the call connection that has now been terminated is to be resumed after conclusion of the emergency call. In a step 214 switching centre MSC1 fulfils the connection request that was received in step 201 and sets up the desired emergency-call connection. The program then proceeds to the end step 2END.

FIG. 3 shows the handling of an incoming connection request for the terminal group GRP in switching centre MSC1 in a step 301. In a step 302 switching centre MSC1 checks whether one or whether several of the terminals M1 to M3 is/are ready to receive and also whether the maximum number of call connections allowed for the terminal group GRP has not yet been reached. If this maximum number has been reached, switching centre MSC1 passes in a transition Y31 to a step 303 in which the switching centre MSC1 signals to the caller that the terminal group GRP is not accessible at the moment. Furthermore, switching centre MSC1 can enter the unsatisfied connection request into a queue for unfulfilled connection requests, e.g. into a “callback on busy” queue. Step 303 leads directly to an end step 3END.

However, if the terminal group GRP is accessible, switching centre MSC1 proceeds in a transition N31 to a step 304 in which the switching centre MSC1 interrogates the data that are relevant to the terminal group GRP. In particular, switching centre MSC1 establishes in step 304 which of the terminals M1 to M3 the present connection request is to be put through to. In the present case the connection request is to be put through to terminal M2. Therefore switching centre MSC1 establishes the desired call connection to terminal M2 in a step 305. If terminal M2 were to be inaccessible at the moment, for instance because it is switched off, switching centre MSC1 could also check in this step which of the terminals M1 or M3 is to be selected as an alternative call destination.

Step 306 is configured in a manner analogous to step 204 from FIG. 2, i.e. switching centre MSC1 checks in step 306 whether terminal M2 or the communication-partner terminal thereof terminate the connection that has now been established. In the event of a negative result, step 306 is repeated in a path N32; in the event of a positive result, switching centre MSC1 arrives in a transition Y32 at step 3END.

The functional sequences represented in FIGS. 2 and 3 are realised as program modules which are preferably executed by the control means CPUSC of switching centre MSC1. Program modules of such a type may, however, also be executed by control means pertaining to access device BTS1 and/or to control device BSC1.

Special function keys or so-called soft keys, that is to say context-dependent function keys, may also be arranged on the terminals M1 to M3, with which the specific functions within the context of the terminal group GRP can be executed. For example, the configuration of the master functions at terminal M1 may be realised via such function keys. Furthermore, it is also possible for the terminals M1 to M3 to intercommunicate. For example, the terminals may be designed not only for communication with the telecommunications network NET but may also be designed, e.g. with the aid of so-called DECT modules (DECT=Digital European Cordless Telecommunication), for direct communication with one another. Furthermore, it may also be predetermined that the terminals M1 to M3 are able to communicate with one another (“internally”) over the telecommunications network NET, specifically when the terminals communicating internally in each instance are located within range of a single access device, e.g. access device BTS1, or of a switching centre, e.g. switching centre MSC1.

1. A process for managing a first and at least one second mobile-radio terminal (M1, M2) which are each able to set up connections over a mobile-radio telecommunications network (NET) to communication-partner terminals (KPM1, KPM2, KPM3), characterised in that
the first and the at least one second terminal (M1, M2) are assigned to a common mobile-radio terminal group (GRP),
a common subscriber number (GRPNR) is assigned to the terminal group (GRP),
a first identifier (ID1) is assigned to the first terminal (M1), and a second identifier (ID2) is assigned to the at least one second terminal (M2) and
the first and the at least one second identifier (ID1, ID2) are evaluated when call connections (C11, C12, C13) are set up over the telecommunications network (NET) between the first terminal (M1) or the at least one second terminal (M2) and the communication-partner terminals (KPM1, KPM2, KPM3).

2. Process according to claim 1, characterised in that a number of simultaneous call connections (C11, C12, C13) for the terminal group to communication-partner terminals (KPM1, KPM2, KPM3) over the telecommunications network is predetermined.

3. Process according to claim 1, characterised in that the first and the at least one second terminal transmit to the telecommunications network (NET) the identifiers (ID1, ID2) assigned to each of them when they log on to said telecommunications network (NET).

4. Process according to claim 1, characterised in that the first and the at least one second identifier (ID1, ID2) are each assigned in the form of a final digit of the subscriber number (GRPNR).

5. Process according to claim 1, characterised in that the first and the at least one second identifier (ID1, ID2) are allocated to the first and to the at least one second terminal (M2), in a manner depending on their logging-on, by the telecommunications network (NET) when the first and the at least one second terminal (M2) log on to the communications network (NET).

6. Process according to claim 1, characterised in that the first or the at least one second terminal (M1, M2) are predetermined as preferred destination for incoming call connections (C11, C12, C13) from the telecommunications network (NET) that are directed to the subscriber number (GRPNR) of the terminal group (GRP).

7. Process according to claim 1, characterised in that a master authorization is assigned to the first (M1) or to the at least one second terminal (M2), which authorises the respective terminal to modify parameters assigned to the terminal group (GRP) and/or parameters assigned to the individual terminals of the terminal group (GRP).

8. Process according to claim 1, characterised in that in the case where there exists a predetermined number of simultaneous call connections (C11, C12, C13) for the terminal group (GRP) the telecommunications network (NET) enters requests for connection to communication-partner terminals (KPM1, KPM2, KPM3) that have been sent from the first or from the at least one second terminal (M2) into a queue and in that the telecommunications network (NET) processes sequentially the connection requests that have been entered in the queue in each instance after said predetermined number has been fallen short of.

9. Process according to claim 8, characterised in that the connection requests that have been entered into the queue are processed in a manner depending on destination call numbers specified in the respective connection requests.

10. Process according to claim 1, characterised in that the telecommunications network (NET) receives a connection request for a predetermined, preferred call connection from or to a terminal of the terminal group (GRP) and in that with a view to fulfilling the connection request the telecommunications network (NET) interrupts or terminates a call connection existing with a terminal of the terminal group (GRP).

11. Process according to claim 1, characterised in that the first terminal (M1) sends an instruction to the mobile-radio telecommunications network (NET) to switch a call connection existing between the first terminal (M1) and a communication-partner terminal (KPM1, KPM2, KPM3) over to the at least one second terminal, and in that the mobile-radio telecommunications network (NET) switches the call connection over to the at least one second terminal.

12. A device (DB) for a mobile-radio telecommunications network (NET) for managing a first and at least one second mobile-radio terminal (M1, M2) which are each able to set up connections over the mobile-radio telecommunications network (NET) to communication-partner terminals (KPM1, KPM2, KPM3), characterized in that
the device comprises assignment means (CPUDB, MEMDB) for assigning the first and the at least one second terminal (M2) to a common mobile-radio terminal group (GRP),
the assignment means (CPUDB, MEMDB) are configured for assigning a common subscriber number (GRPNR) to the terminal group (GRP),
the device comprises management means (CPUDB, MEMDB) for managing a first identifier (ID1) assigned to the first terminal (M1) and a second identifier (ID2) assigned to the at least one second terminal (M2) and
the device comprises evaluating means (CPUDB, MEMDB) for evaluating the first and the at least one second identifier (ID1, ID2) when call connections (C11, C12, C13) are set up over the telecommunications network (NET) between the first terminal (M1) or the at least one second terminal (M2) and the communication-partner terminals (KPM1, KPM2, KPM3).

13. A program module for a device (DB) of a mobile-radio telecommunications network (NET) for managing a first and at least one second mobile-radio terminal (M1, M2), which are each able to set up connections over the mobile-radio telecommunications network (NET) to communication-partner terminals (KPM1, KPM2, KPM3), the program module comprising command code that can be executed by a control means (CPUDB) of the device, characterised in that
the program module comprises assignment means for assigning the first (M1) and the at least one second terminal (M2) to a common mobile-radio terminal group (GRP),
the assignment means are configured for assigning a common subscriber number (GRPNR) to the terminal group (GRP),
the program means comprises management means for managing a first identifier (ID1) assigned to the first terminal (M1) and a second identifier (ID2) assigned to the at least one second terminal (M2) and
the program module comprises evaluating means for evaluating the first and the at least one second identifier (ID1, ID2) when call connections (C11, C12, C13) are set up over the telecommunications network (NET) between the first terminal (M1) or the at least one second terminal (M2) and the communication-partner terminals (KPM1, KPM2, KPM3).

14. A (first) mobile-radio terminal (M1) which is managed by a mobile-radio telecommunications network (NET) over which the first terminal (M1) and at least one second mobile-radio terminal are each able to set up connections to communication-partner terminals (KPM1, KPM2, KPM3), characterised in that the terminal comprises recognition means (M1CPU, M1MEM) which are configured in such a way that the terminal can ascertain that it is assigned together with the at least one second terminal (M2) to a common mobile-radio terminal group (GRP), in that the terminal comprises evaluating means (M1CPU, M1MEM) which are configured in such a way that the terminal can evaluate a common subscriber number (GRPNR) assigned to the terminal group (GRP) as well as a terminal-specific identifier (ID1) assigned to the terminal, and in that the terminal comprises call-setup means (M1TR, M1CPU) which are configured in such a way that the terminal can evaluate the identifier (ID1) when a call connection (C11) is set up over the telecommunications network (NET) to a communication-partner terminal (KPM1, KPM2, KPM3).

15. A program module for a (first) mobile-radio terminal which is managed by a mobile-radio telecommunications network (NET) over which the first terminal (M1) and at least one second mobile-radio terminal are each able to set up connections to communication-partner terminals (KPM1, KPM2, KPM3), the program module comprising command code that can be executed by a control means (M1CPU) of the mobile-radio terminal, characterised in that the program module comprises recognition means which are configured in such a way that the program module can ascertain that the first terminal (M1) is assigned together with the at least one second terminal (M2) to a common mobile-radio terminal group (GRP), in that the program module comprises evaluating means which are configured in such a way that the program module can evaluate a common subscriber number (GRPNR) assigned to the terminal group (GRP) as well as a terminal-specific identifier (ID1) assigned to the first terminal (M1), and in that the program module comprises call-setup means which are configured in such a way that the program module can evaluate the identifier (ID1) when a call connection of the first terminal (M1) is set up over the telecommunications network (NET) to a communication-partner terminal (KPM1, KPM2, KPM3).

16. An identification module for a (first) mobile-radio terminal which is managed by a mobile-radio telecommunications network (NET) over which the first terminal (M1) and at least one second mobile-radio terminal are each able to set up connections to communication-partner terminals (KPM1, KPM2, KPM3), the identification module comprising memory means that are capable of being evaluated by the first mobile-radio terminal, characterised in that the identification module comprises a common subscriber number (GRPNR) assigned to the terminal group (GRP) as well as a terminal-specific identifier (ID1) assigned to the terminal, which the first terminal can evaluate when a call connection is set up over the telecommunications network (NET) to a communication-partner terminal (KPM1, KPM2, KPM3) and on the basis of which the first terminal can ascertain that it is assigned together with the at least one second terminal (M2) to a common mobile-radio terminal group (GRP).

17. A switching centre with a device according to claim 12.

18. A base station with a device according to claim 12.

19. A storage medium, in particular a computer-readable diskette, with a program module according to claim 13 and/or a program module according to claim 15.
